(19) United States
(12) Patent Application Publication
(10) Pub. No.: US 2010/0125821 A1
(43) Pub. Date: May 20, 2010

(54) Design support method

(75) Inventor: Syogo Tajima, Tokyo (JP)

Correspondence Address: STAAS & HALSEY LLP, SUITE 700, 1201 NEW YORK AVENUE, N.W., WASHINGTON, DC, 20005, US

(73) Assignee: Fujitsu Microelectronics Limited, Tokyo (JP)

(21) Appl. No.: 12/588,919

(22) Filed: Nov. 2, 2009

(30) Foreign Application Priority Data
Nov. 14, 2008 (JP) 2008-291759

(51) Int. Cl. G06F 17/50

(52) U.S. Cl. 716/5; 716/12

(57) ABSTRACT

A method for a design support is provided. The method includes a computer that executes processes of detecting a combination of vias comprising a target via and a neighboring via-; calculating a distance between the combination of the target via and the neighboring via, replacing a shape of the target via and a shape of at least one of the neighboring via with a shape of an exposure pattern of the via, searching the adjacent wiring arranged within the distance between the vias or less from a position of the target via after the process of replacing, and converting the position of the neighboring via to which the process of replacing is applied to the position searched by the process of searching and storing the position in the database; and outputting the layout data converted by the process of converting.

### CROSS-REFERENCES TO RELATED APPLICATIONS

This application is related to and claims priority to Japanese Patent Application No. 2008-291759, filed on Nov. 14, 2008, and incorporated herein by reference.

### BACKGROUND

1. Field

The embodiments disclosed herein relate to a power supply wiring of a semiconductor integrated circuit and a design support method for implementing the wiring.

2. Description of the Related Art

In designing a layout of a semiconductor integrated circuit, there is an arrangement and wiring method to improve a degree of the integration when a power supply wiring and arrangement are performed. Conventionally, a process called a layout compaction shortens a distance between parts comprising a semiconductor integration circuit.

Conventionally to prevent causing a difference between a part shape included in layout data and the part shape after the fabrication, a process verifies a layout by defining a design standard based on an actual shape after the fabrication.

However, the layout compaction pays attention only to a distance between parts; and results in a drawback that an area of a semiconductor integrated circuit changes depending on shapes of parts. Moreover, the layout verification process in which design standards are defined based on shapes of parts after the fabrication, processes by an automatic arrangement wiring tool are increased. This leads to a problem that the processes take longer. Moreover, increase in design standards leads to longer design hours when layout is designed manually. Violations of the design standard may increase, and thereby the verification takes longer time.

### SUMMARY

It is an aspect of the embodiments disclosed herein to provide a method for a design support. The method includes when executed by a computer executes processes of detecting a combination of wirings comprising a target wiring selected from wirings in the layout data and an adjacent wiring that is in parallel with and in substantially the same layer as the target wiring, detecting a combination of vias comprising a target via selected from rectangular vias arranged on the target wiring and a neighboring via that is in substantially the same layer as the target via and arranged on the adjacent wiring; calculating a distance between the combination of the target via and the neighboring via detected by the process of detecting the vias; replacing a shape of the target via and a shape of at least one of the neighboring via with a shape of an exposure pattern of the via, searching the adjacent wiring arranged within the distance between the vias or less from a position of the target via after the process of replacing; converting the position of the neighboring via to which the process of replacing is applied to the position searched by the process of searching and storing the position in the database; and outputting the layout data converted by the process of converting.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1A illustrates exemplary layout data in which a distance between vias is a reference value of a design standard;

FIG. 1B illustrates exemplary layout data in which a distance between vias is a reference value N or more;

FIG. 2A illustrates exemplary layout data of a neighboring via rearranged after converting the shape;

FIG. 2B illustrates exemplary layout data of a target via rearranged after converting the shape;

FIG. 2C illustrates exemplary layout data of a target via and a neighboring via rearranged after converting the shapes;

FIG. 3 illustrates exemplary physical information of layout data;

FIG. 4 illustrates an exemplary design standards table;

FIG. 5A illustrates an example in which vias are arranged with an interval of a reference value “M”;

FIG. 5B illustrates shapes of exposure patterns of rectangular vias;

FIG. 6A illustrates shapes of vias;

FIG. 6B illustrates shapes of vias when an adjacent via exists;

FIG. 7 illustrates a hardware configuration of an exemplary the design support system;

FIG. 8 illustrates a design support system;

FIG. 9A illustrates a exemplary redundant via that is an adjacent via;

FIG. 9B illustrates an exemplary adjacent via;

FIG. 10A illustrates replacing a shape of a neighboring via 104 with a via shape 601;

FIG. 10B illustrates replacing the shape of the neighboring via 104 with the via shape 601;

FIG. 10C illustrates replacing the shape of the neighboring via 104 with the via shape 602;

FIG. 10D illustrates a third example of replacing the shape of the neighboring via 104 with the via shape 601;

FIG. 10E illustrates a second example of replacing the shape of the neighboring via 104 with the via shape 602;

FIG. 11A illustrates a position searched by a search unit 805;

FIG. 11B illustrates a neighboring via 201 whose position is converted;

FIG. 11C illustrates the neighboring via 201 whose position is converted to the position where the distance between vias is the reference value “N”;

FIG. 12A illustrates a target via and a neighboring via whose shapes are replaced by a replacement unit 804;

FIG. 12B illustrates a position searched by a search unit 805;

FIG. 12C illustrates the neighboring via 201 whose position is converted;

FIG. 12D illustrates the neighboring via 201 whose position is converted to the position where the distance between vias is the reference value N;

FIG. 13 illustrates exemplary procedures of a design support system;

FIG. 14 illustrates an exemplary detecting of vias; and

FIG. 15 illustrates exemplary replacing and rearranging vias.

### DETAILED DESCRIPTION OF EMBODIMENTS

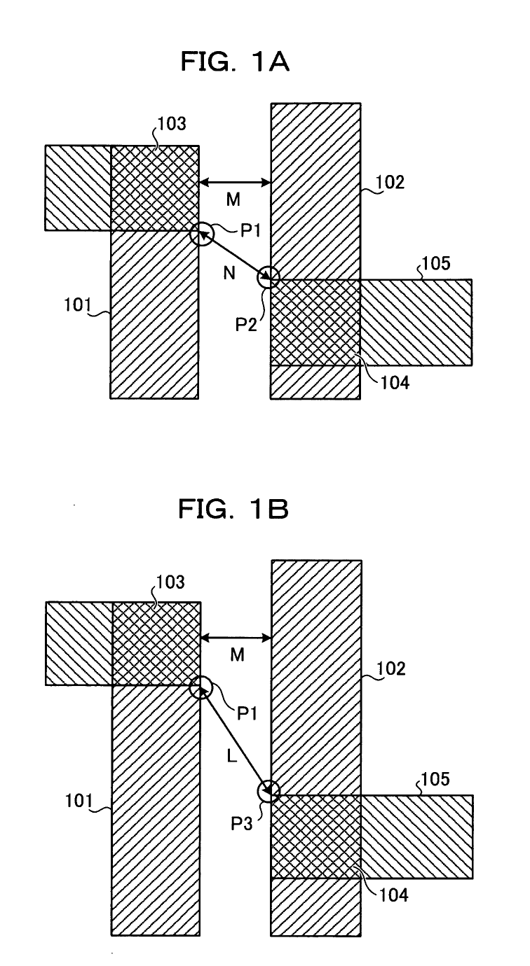

In an exemplary embodiment, two vias may be automatically arranged to approach each other by converting a power supply wiring and shapes of the vias on the wiring included in layout data into a via pattern after the fabrication. Furthermore, a distance between vias after converting the shapes of the vias may be a reference value of design standards or more, and a distance between the vias before converting the shapes or less. FIGS. 1A and 1B illustrate exemplary wirings included in layout data.

FIG. 1A illustrates exemplary layout data in which a distance between vias is a reference value of a design standard. In the layout data in FIG. 1A, the following may be formed; a target wiring 101, an adjacent wiring 102 that is in parallel with and in substantially the same layer as the target wiring 101, a target via 103 on the target wiring 101, a neighboring via 104 on the adjacent wiring 102, a coupling target wiring 105 that is coupled to the adjacent wiring 102 by way of the neighboring via 104. Shapes of the target via 103 and the neighboring via 104 may be rectangular.

A distance between wirings that is a distance between the target wiring 101 and the adjacent wiring 102 may be a reference value “M.”

The reference value “M” may be a reference value of a distance between wirings included in a design standards table that will be described later. A distance between vias may be a distance from a point P1 of the target via 103 to a point P2 of the neighboring via 104. A distance between vias in FIG. 1A may be a reference value “N.”

FIG. 1B illustrates exemplary layout data in which a distance between vias is a reference value “N” or more. In FIG. 1B, a distance between vias that is from the target via 103 to the neighboring via 104 is “L” (μm) that is longer than the reference value “N.” The distance between vias may be from the point P1 of the target via 103 to the point P3 of the neighboring via 104. According to this embodiment, a shape of a via may be changed from a rectangle to an exposure pattern. The shape of the exposure pattern is a via pattern obtained by applying exposure to vias during fabrication. The target via 103 and the neighboring via 104 may be automatically rearranged in a direction that the two vias approach closer.

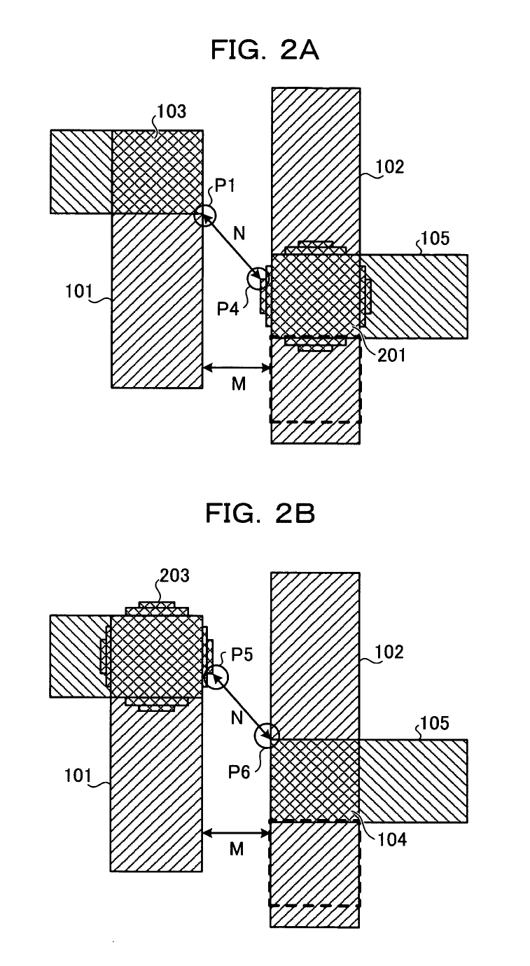

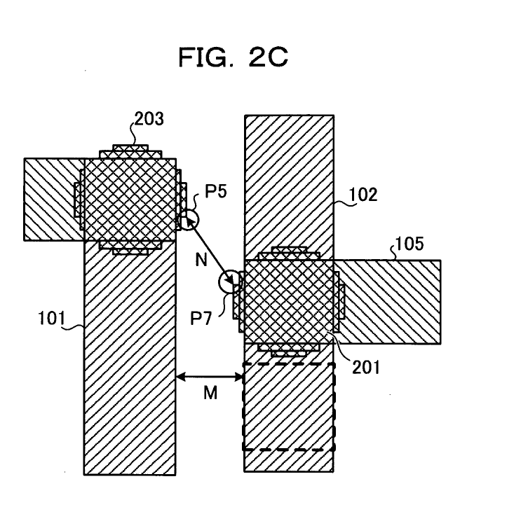

FIGS. 2A to 2C illustrate rearranged vias after converting the shapes.

FIG. 2A illustrates exemplary layout data of a neighboring via rearranged after converting the shape. A neighboring via 201 may be a neighboring via 104 whose shape is converted. In FIG. 2A, vias may be rearranged so that a distance from a point P1 of the target via 103 to a point P4 of the neighboring via 201 is a reference value “N.” The position of the neighboring via 201 after the rearrangement may be closer to the target via 103 compared to the position where the neighboring via 104 is located before the rearrangement (a quadrilateral region indicated by the dotted line). FIG. 2B illustrates the target via 103 rearranged after converting the shape.

FIG. 2B illustrates exemplary layout data of a target via rearranged after converting the shape. A target via 203 may be a target via 103 whose shape is converted. In FIG. 2B, vias may be rearranged so that a distance from a point P5 of the target via 203 to a point P6 of the neighboring via 104 becomes a reference value N. The position of the neighboring via 104 after the rearrangement may be closer to the target via 103 compared to the position where the neighboring via 104 is located before the rearrangement (a quadrilateral region indicated by the dotted line).

FIG. 2C illustrates exemplary layout data of a target via and a neighboring via rearranged after converting the shapes. A target via 203 may be a target via 103 whose shape is converted. A neighboring 201 may be a neighboring 104 whose shape is converted. In FIG. 2C, the neighboring 201 may be rearranged so that a distance from a point P5 of the target via 203 to a point P7 of the neighboring 201 is a reference value N. The position of the neighboring 201 after the rearrangement may be closer to the target via 203 compared to the position where the neighboring 104 is located before the rearrangement (a quadrilateral region indicated by the dotted line).

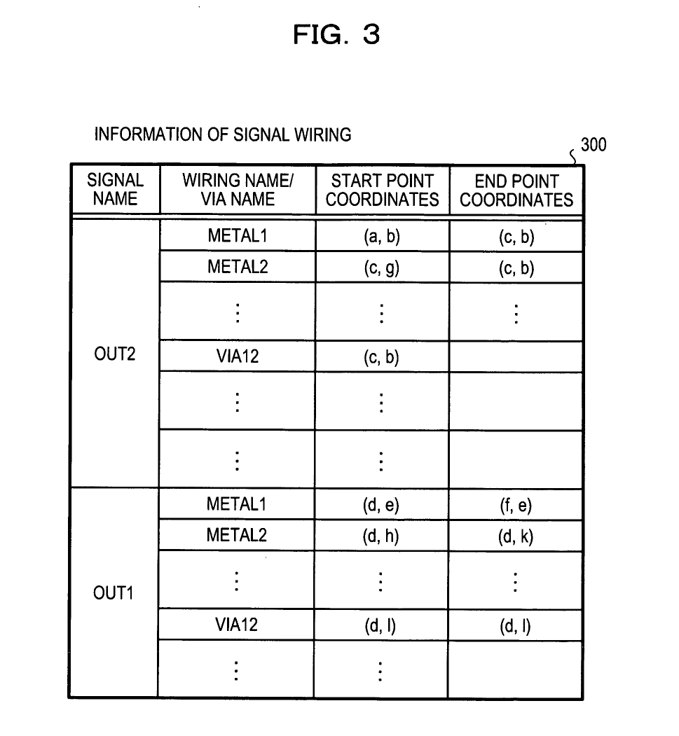

FIG. 3 illustrates exemplary physical information of layout data. For example, a physical information of signal wiring 300 may include a signal name, a wiring name/a via name, start point coordinates (X, Y) and end point coordinates (X, Y). For example, in a signal name OUT2, information where METAL1 and METAL2 overlaps, METAL1 may be arranged from start point coordinates (a, b) to end point coordinates (c, b), while METAL2 may be arranged from start point coordinates (c, g) to end point coordinates (c, b). The VIA 12 may couple the two wirings at the coordinates (c, b). The physical information of signal wiring 300 may be stored in a storage device.

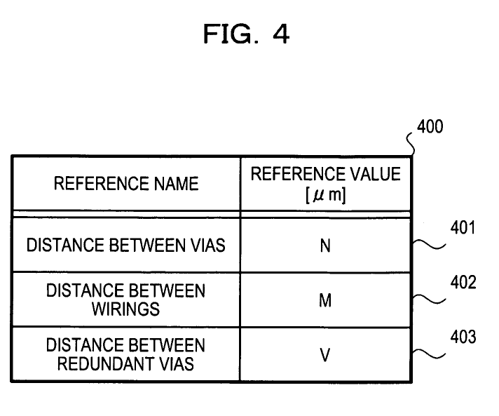

FIG. 4 illustrates an exemplary design standards table. A table 400 may retain records whose attributes are a reference name and a reference value for each of the design standards. A record 401 may be a design standard in which a distance between vias is a reference value “N” (μm) (hereunder, a design standard 401). A record 402 may be a design standard in which a distance between wirings is a reference value “M” (μm) (hereunder, a design standard 402). A record 403 may be a design standard in which a distance between redundant vias is a reference value “V” (μm). The table 400 may be stored in a storage device.

For example, arrangement may be performed based on a design standard by referring to the table 400. Recently, the reference value “N” of the design standard 401 is longer than the reference value “M” of the design standard 402.

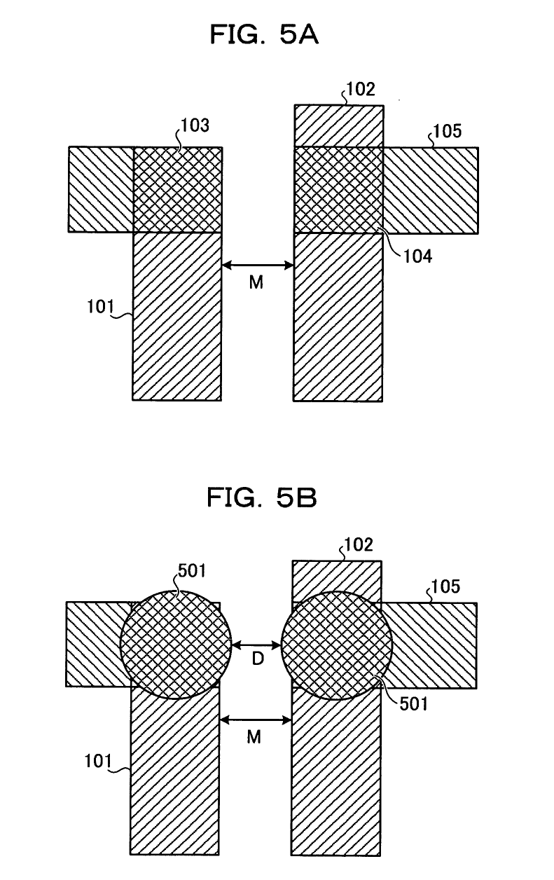

FIG. 5A illustrates exemplary vias arranged with an interval of a reference value “M.” In FIG. 5A, a distance between a target via 103 and a neighboring 104 may be a reference value “M.” When vias are arranged facing each other with an interval of the reference value “M”, the degree of integration is improved. Thus, in designing a layout, placing vias as close as possible is desirable. FIG. 5B illustrates an example when vias are fabricated using a layout data in which vias are facing each other.

FIG. 5B illustrates exemplary shapes of exposure patterns of rectangular vias. The shape of the exposure pattern may be a via pattern obtained by applying exposure to vias during fabrication. For example, when a via is rectangular, in FIG. 5B, a shape of via pattern after applying exposure (shape of exposure pattern 501) may be a circle larger than the rectangle shape before the exposure. Thus, a distance between vias “D” is shorter than a reference value “M.” This means the distance between vias “D” violates the design standard. Therefore, the reference value “N” is set longer than the reference value “M.”

Thus, when a wiring is arranged using the reference value “M”, vias are not arranged facing each other.

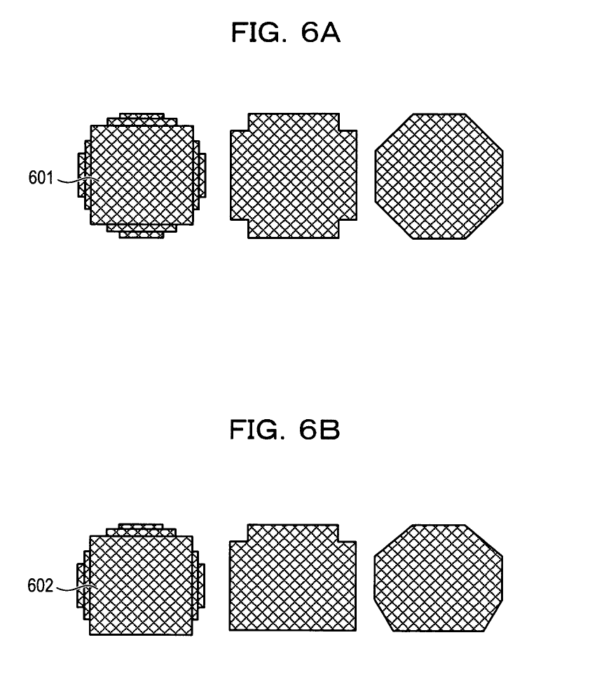

However, the shape of the exposure pattern 501 is circular, thus an area smaller than the rectangular shape exists. Therefore, vias are arranged closer by converting the rectangular vias into the shape of the exposure pattern 501. FIGS. 6A and 6B illustrate shapes of vias prepared based on the shape of the exposure pattern 501.

FIG. 6A illustrates exemplary shapes of vias. In FIG. 6A, shapes of vias prepared based on shapes of exposure patterns are depicted. According to this embodiment, a rectangular via shape may be converted into a via shape 601. For example, the via shape 601 may be prepared for each of the via layers. The via shape may be converted by changing a name of a via to be converted to the via shape 601 in a physical information of signal wiring information 300.

FIG. 6B illustrates exemplary shapes of vias when an adjacent via exists. For example, when an adjacent via, which will be described later, exists in the neighboring 104, the shape of neighboring 104 may be converted into an exposure pattern of the via except for one side.

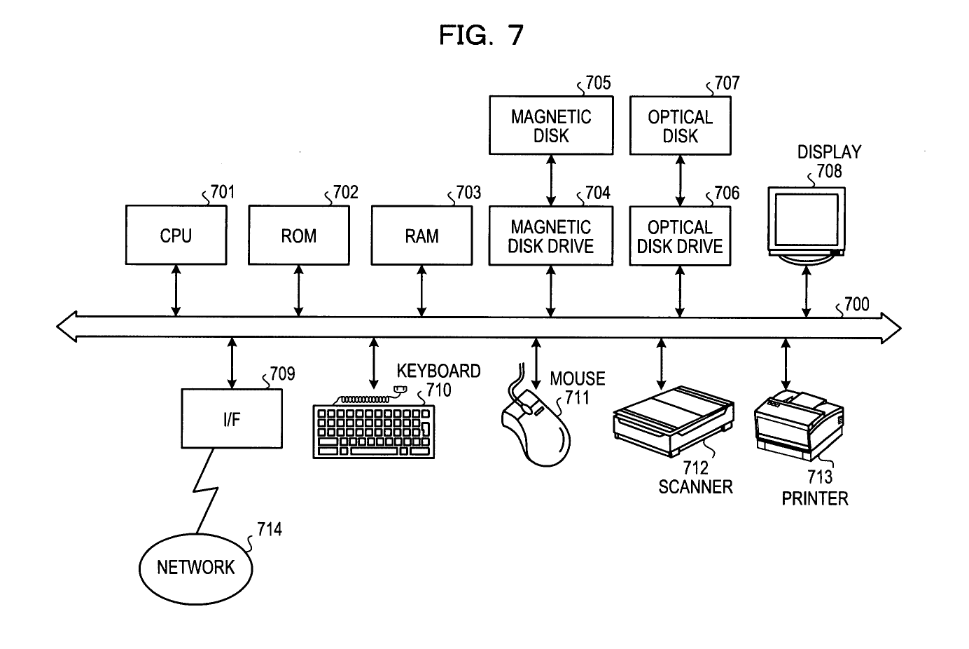

FIG. 7 illustrates a hardware configuration of a design support system according to this embodiment. In FIG. 7, the design support system includes a central processing unit (CPU) 701, a read-only memory (ROM) 702, a random access memory (RAM) 703, a magnetic disk drive 704, a magnetic disk 705, an optical disk drive 706, an optical disk 707, a display 708, an interface (I/F) 709, a keyboard 710, a mouse 711, a scanner 712, and a printer 713. Each of the components may be coupled by way of a bus 700 respectively.

In this case, the CPU 701 may control an entire design support system. A program such as a boot program may be stored in the ROM 702. The RAM 703 may be used as a work area for the CPU 701. The magnetic disk drive 704 may control reading and writing of data to and from the magnetic disk 705 by control of the CPU 701. The magnetic disk 705 may store data written by control of the magnetic disk drive 704.

The optical disk drive 706 may control reading and writing data to and from the optical disk 707, for example, by control of the CPU 701. The optical disk 707 may store data written by control of the optical disk drive 706 or causing a computer to read data stored in the optical disk 707.

The display 708 may display a cursor, an icon, a toolbox, and data such as a text, an image, and other information. As the display 708, a cathode-ray tube (CRT), a thin film transistor (TFT) liquid crystal display, and a plasma display may be employed.

The interface (hereunder abbreviated as I/F) 709 may be coupled to a network 714 such as a Local Area Network (LAN), a Wide Area Network (WAN), and the Internet, and may be coupled to other devices by way of the network 714. The I/F 709 controls interface between the network 714 and the internal components, and may control input and output of data to and from external devices. As the I/F 709, a modem or a LAN adapter may be employed.

The keyboard 710 provides keys for inputting characters, numerical numbers, and various instructions and may perform data input. The keyboard 710 may be a touch panel type input pad and a numeric-keypad. The mouse 711 may move a cursor, select an area, move a window, and change a window size. The mouse 711 may be a track ball or a joy stick operate as a pointing device.

The scanner 712 optically reads an image, and may store the image data in the design support system. The scanner 712 may operate as an optical character reader. The printer 713 may print image data and document data. The printer data 713 may be a laser printer, or an ink jet printer.

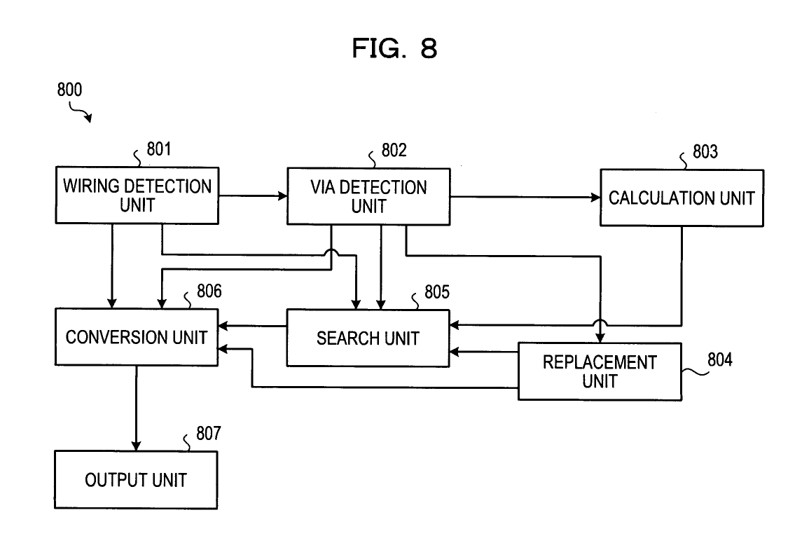

FIG. 8 illustrates a design support system. The design support system 800 includes a wiring detection unit 801, a via detection unit 802, a calculation unit 803, a replacement unit 804, a search unit 805, a conversion unit 806, and an output unit 807.

The wiring detection unit 801, the via detection unit 802, the calculation unit 803, the replacement unit 804, the search unit 805, the conversion unit 806, and the output unit 807 of the design support system 800 may cause the CPU 701 to executes programs stored in a storage device such as the ROM 702, the RAM 703, the magnetic disk 705, or the optical disk 707 or by the I/F 709.

The wiring detection unit 801 determines a target wiring 101 from layout data, and detects a combination of the target wiring 101 and an adjacent wiring 102 which is in parallel with and in substantially the same layer as the target wiring 101. The CPU 701 accesses a storage device and sequentially selects wirings from the physical information of signal wiring 300 and the selected wiring may be assumed as the target wiring 101. For example, the selected wiring may be stored in the storage device by adding identification information that indicates the wiring is the target wiring 101.

A wiring which is in parallel with and adjacent to the target wiring 101 is extracted using a layer name of the target wiring 101 and the coordinates and the extracted wiring is assumed to be the adjacent wiring 102. For example, the extracted wiring may be stored in the storage device by adding identification information that indicates the wiring is the adjacent wiring 102. The target wiring 101 and the adjacent wiring 102 may be a wiring combination.

For example, the CPU 701 may store a combination of wirings in the storage device that comprises a wiring to which identification information indicating the wiring is the target wiring 101 is added and a wiring to which identification information that indicates the wiring is the adjacent wiring 102 is added by further adding identification information that indicates the two wirings are the wiring combination of the target and the adjacent wirings.

Moreover, the wiring detection unit 801 may detect the coupling target wiring 105 that is coupled to the adjacent wiring 102 by way of the neighboring 104 after detecting the neighboring 104 by the via detection unit 802, which will be described later. The combination of the wiring 102 and the coupling target wiring 105 may be detected.

For example, the CPU 701 may access the storage device and read information on the neighboring 104 based on the identification information. The CPU 701 may access the storage device to search and retrieve the coordinates of the neighboring 104 from the physical information of signal wiring 300. A wiring that is on coordinates of the found neighboring 104 and that is not the adjacent wiring 102 may be detected as a coupling target wiring 105. For example, the wiring may be stored in the storage device by adding identification information that indicates the wiring is the coupling target wiring 105.

The adjacent wiring 102 and the coupling target wiring 105 may be a wiring combination. For example, the pair of wirings may be stored in the storage device by adding identification information that indicates the wirings is the wiring combination of the adjacent and the coupling target wirings.

The via detection unit 802 determines a target via 103 among vias exist on the target wiring 101 of the wiring combination detected by the wiring detection unit 801 and may detect a combination of the target via 103 and the neighboring 104 that is in substantially the same layer as the target via 103 and exists on the adjacent wiring.

For example, the CPU 701 may access the storage device and read information on the target wiring 101 based on the identification information. The CPU 701 may access the storage device, search and retrieve coordinates of the target wiring 101 from the physical information of signal wiring 300. A via that exists on coordinates of the target wiring 101. The detected via may be assumed to be a target via 103. For example, the detected via may be stored in the storage device by adding identification information that indicates the via is the target via 103.

The CPU 701 may access the storage device, search and retrieve the coordinates of the adjacent wiring 102 and detect a via that exists on the adjacent wiring 102. Then the detected via may be assumed to be the neighboring via 104. For example, the detected via may be stored in the storage device by adding identification information that indicates the via is the neighboring via 104. The target via 103 and the neighboring via 104 may be a combination of vias.

For example, the CPU 701 may store a pair of vias in the storage device that comprises a via to which identification information that indicates the via is the target via 103 is added and a via to which identification information that indicates the via is the neighboring via 104 is added by further adding identification information that indicates the pair is the combination of the target and the neighboring vias.

The via detection unit 802 may detect the neighboring via 104 and the adjacent via that exists within a given distance from the neighboring via 104 on the adjacent wiring 102 as a combination of the vias.

If the adjacent via exists, a replacement unit 804, which will be described later, may replace the shape of the neighboring via 104 with the via shape 602. For example, an adjacent via which has substantially the same potential as the neighboring via 104 may be arranged in the position where the distance between vias is a reference value V. In this case, when the replacement unit 804, which will be described later, replaces the shape of the neighboring via 104 with the via shape 601, the distance between the neighboring via 104 and the adjacent via may violate design standards. Thus, the via detection unit 802 may detect the adjacent via.

For example, the CPU 701 may access the storage device and reads information on the neighboring via 104 and the adjacent wiring 102 based on the identification information. The CPU 701 may access the storage device, search and retrieve the coordinates of the adjacent wiring 102 and the neighboring via 104 from the physical information of signal wiring 300. A via that is on the retrieved adjacent wiring 102 and within a given distance Q (μm) from the neighboring via 104 may be detected. The detected via may be assumed as the adjacent via. For example, the detected via may be stored in the storage device by adding identification information that indicates the via is the adjacent via.

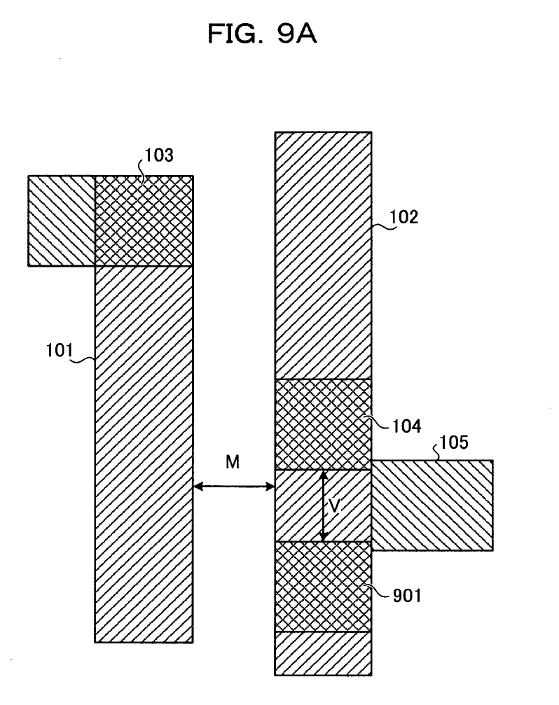

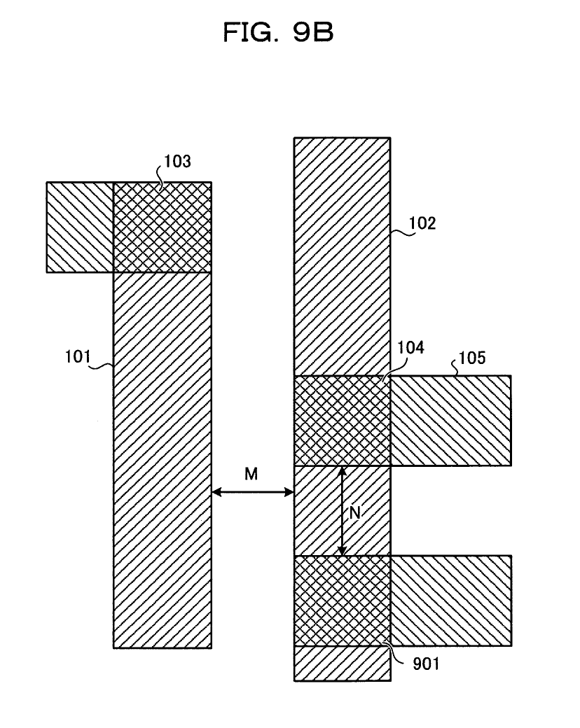

The neighboring via 104 and the adjacent via may be a combination of vias. For example, a pair of vias may be stored in the storage device that comprises a via to which identification information that indicates the via is the neighboring via 104 is added and a via to which identification information that indicates the via is the adjacent via is added by further adding identification information that indicates the pair is the combination of the neighboring via and the adjacent via. FIGS. 9A and 9B illustrate exemplary adjacent vias.

FIG. 9A illustrates an exemplary redundant via that is an adjacent via. The redundant via may be multiple vias for coupling two wirings. In FIG. 9A, an adjacent wiring 102 and a coupling target wiring 105 may be coupled via the neighboring via 104 and the adjacent via 901. The distance between the redundant vias is the reference value “V.” For example, when the neighboring via 104 is a redundant via, a via that couples substantially the same two wirings may be an adjacent via 901. FIG. 9B illustrates an example of the adjacent via 901 which is not a redundant via.

FIG. 9B illustrates an exemplary adjacent via. For example, the adjacent via 901 may be a via arranged in a position where distance between the adjacent via 901 and the neighboring via 104 is the reference value “N.”

The calculation unit 803 may calculate a distance from the target via 103 detected by the via detection unit 802 to the neighboring via 104. For example, the CPU 701 may access the storage device and reads information on the target via 103 based on the identification information. Coordinates of the target via 103 may be searched and retrieved from the physical information of signal wiring 300. Then, coordinates of a point P1 of the target via 103 may be calculated.

Coordinates of the neighboring via 104 may be searched. Coordinates of a point P3 of the neighboring via 104 may be calculated. Moreover, the distance between the calculated point P1 of the target via 103 to a point P3 of the neighboring via 104 is calculated. The calculated result may be assumed as a distance between vias that is from the target via 103 to the neighboring via 104. The calculated distance of vias (hereunder, called “calculated value L”) may be stored in a storage device such as the ROM 702, the RAM 703, the magnetic disk 705, and the optical disk 707.

The replacement unit 804 may replace the shape of at least one of the target via 103 or the neighboring via 104 with the exposure pattern of the relevant via. In the first case, a via to be replaced may only be the neighboring via 104. In the second case, the via to be replaced may only be the target via 103. In the third case, vias to be replaced may be the target via 103 and the neighboring via 104.

Processing of the replacement unit 804, the search unit 805 and the conversion unit 806 in the first case will be described. Subsequently, processing of the replacement unit 804, the search unit 805 and the conversion unit 806 in the third case will be described.

In the first case, the CPU 701 may access the storage device and read information on the neighboring via 104 based on the identification information. The CPU 701 may access the storage device and search and retrieve the neighboring via 104 from the physical information of signal wiring 300. The via name of the via shape 601 may be written to the via name of the neighboring via 104. The neighboring via 104 to which the replacement is applied may be assumed as the neighboring via 201. For example, the neighboring via 104 to which the replacement is applied may be stored in the storage device by adding identification information that indicates the via is the neighboring via 201.

The layout data after applying the replacement may be stored in the storage device such as the ROM 702, RAM 703, the magnetic disk 705, and the optical disk 707.

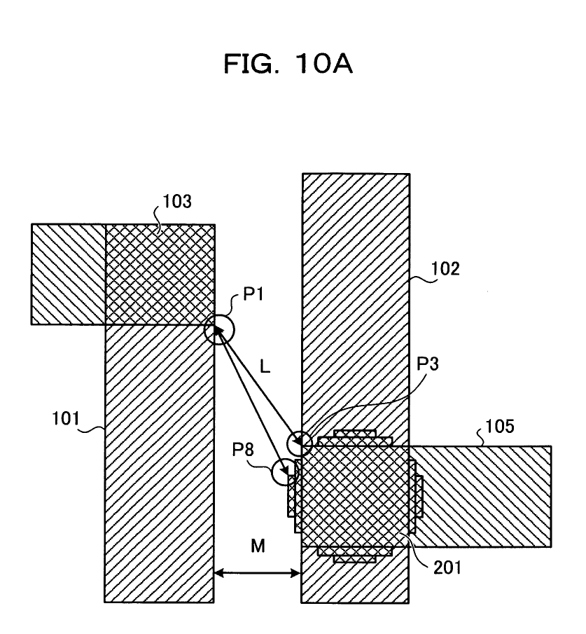

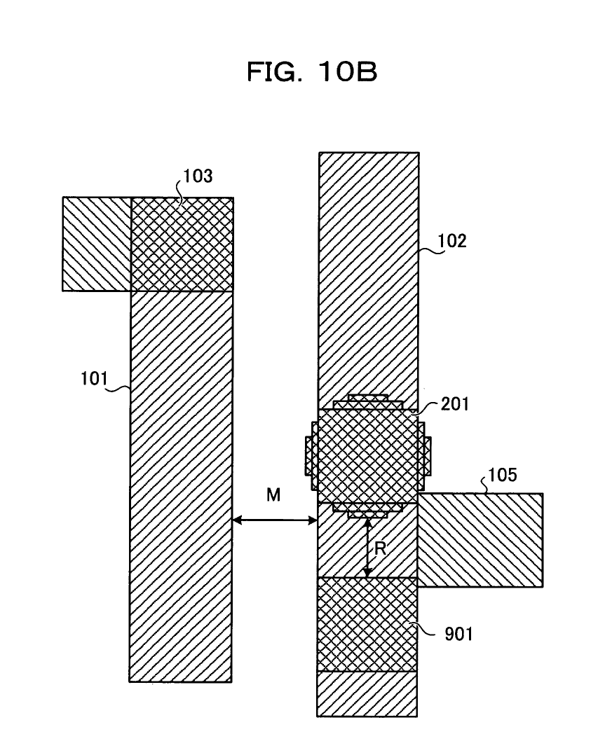

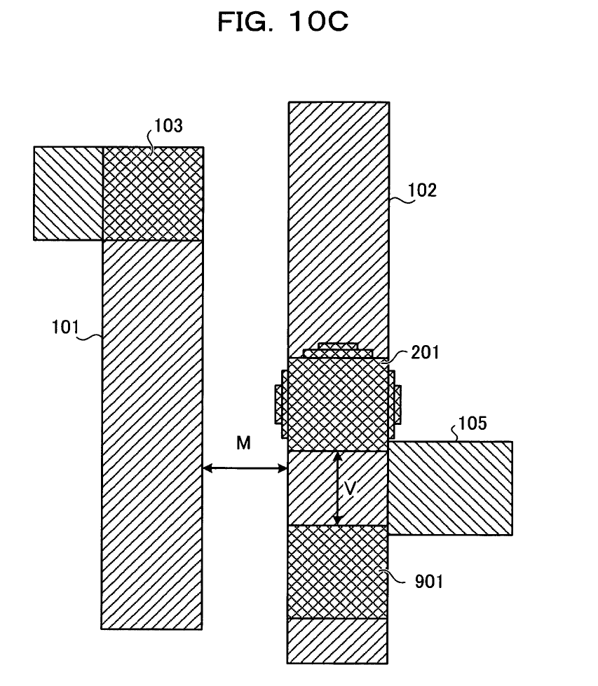

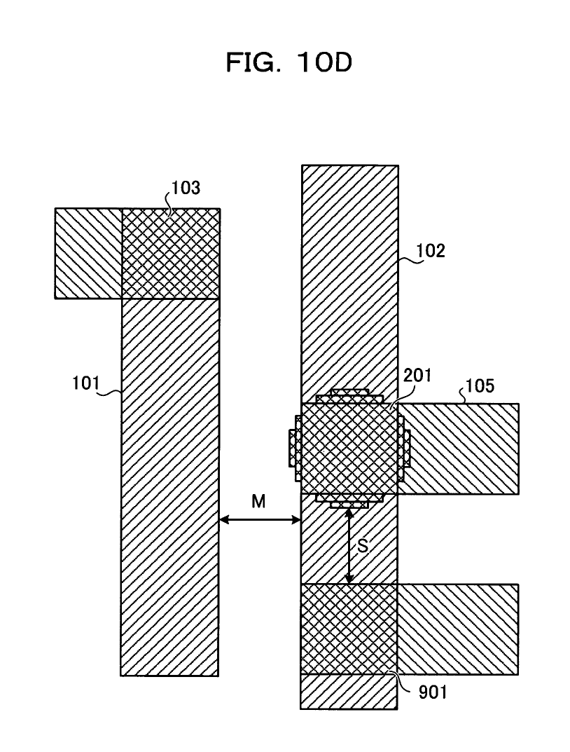

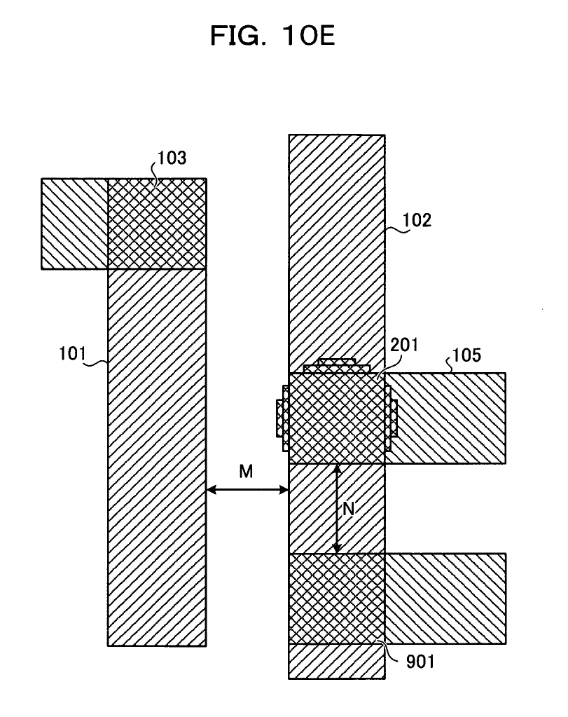

FIG. 10A illustrates replacing a shape of a neighboring via 104 with a via shape 601. A neighboring via 201 may be a via whose shape is replaced from that of the neighboring via 104 to the via shape 601 by the replacement unit 804. The distance between vias may be a distance from a point P1 of the target via 103 to a point P8 of the neighboring via 201. In other words, the distance between vias after the replacement is longer than that of the calculated value L, and the neighboring via 201 may be rearranged in a direction approaching the target via 103.

Now returning to FIG. 8, the replacement unit 804 may replace the shape of the neighboring via 104 with the via shape 602 if the via detection unit 802 detects a combination of the neighboring via 104 and the adjacent via 901. For example, the CPU 701 may access the storage device and read information on the neighboring via 104 based on the identification information. The CPU 701 may access the storage device and search and retrieve the neighboring via 104 from the physical information of signal wiring 300. The via name of the via shape 602 may be written to the via name of the neighboring via 104. The neighboring via 104 to which the replacement is applied may be assumed as the neighboring via 201. For example, the neighboring via 104 to which the replacement is applied may be stored in the storage device by adding identification information that indicates the via is the neighboring via 201.

The layout data after applying the replacement may be stored in the storage device such as the ROM 702, RAM 703, the magnetic disk 705, and the optical disk 707. FIGS. 10B to 10E illustrate examples of replacing the shape of the neighboring via 104 when the adjacent via 901 exists.

FIG. 10B illustrates replacing the shape of the neighboring via 104 with the via shape 601. In FIG. 10B, the shape of the neighboring via 104 may be replaced with the via shape 601. The distance between vias from the neighboring via 201 after applying the replacement to the adjacent via 901 that is a redundant via may be “R” (μm). The distance between vias “R” is shorter than the reference value “V” of the design standard 403, thus the distance between vias “R” violates the design standard. Therefore, if the adjacent via 901 exists, the shape of the neighboring via 104 may be replaced with the via shape 602. FIG. 10C illustrates an example of replacing the shape of the neighboring via 104 with the via shape 602.

FIG. 10C illustrates replacing the shape of the neighboring via 104 with the via shape 602. In FIG. 10C, the shape of the neighboring via 104 may be replaced with the via shape 602. Thus, the distance between vias is a reference value “V”, and may comply with the design standard. FIG. 10D illustrates an example of replacing the shape of the neighboring via 104 with the via shape 601.

FIG. 10D illustrates replacing the shape of the neighboring via 104 with the via shape 601. In FIG. 10D, the shape of the neighboring via 104 may be replaced with the via shape 601. The distance between vias from the neighboring via 201 to the adjacent via 901 after the replacement may be “S” (μm).

The distance between vias “S” is shorter than the reference value “N” of the design standard 401, thus the distance between vias “S” violates the design standard. Therefore, if the adjacent via 901 exists, the shape of the neighboring via 104 may be replaced with the via shape 602. FIG. 10E illustrates an example of replacing the shape of the neighboring via 104 with the via shape 602.

FIG. 10E illustrates exemplary replacing the shape of the neighboring via 104 with the via shape 602. As a result of replacing the shape of the neighboring via 104 with the via shape 602, the distance between the vias may comply with the reference value “N” of the design standard 401.

Hence, the distance between vias from the neighboring via 201 to the adjacent via 901 may not be changed even after the shape of the neighboring via 201 is converted. This may eliminate operation to rearrange the adjacent via 901.

Now, returning to FIG. 8, the search unit 805 may search and retrieve a position where the neighboring via 201 is arranged with the distance between vias from the target via 103 to the neighboring via 201 to which the replacement is applied by the replacement unit 804 is the reference value “N” or more, and the calculated value “L” or less.

For example, the CPU 701 may access the storage device and read information on the neighboring via 201 based on the identification information. The CPU 701 may access the storage device, search and retrieve the coordinates of the neighboring via 201 from the physical information of signal wiring 300. Then, “A” μm (for example, 0.1 μm) may be added to the coordinates of the neighboring via 201 on the adjacent wiring 102 and in the direction where the target via 103 is arranged. After that, the distance between vias is calculated. Moreover, the processing of adding “A” to the calculated distance between vias may be repeated. A position of the neighboring via 201 where the distance between vias is the calculated value “L” may be searched and retrieved. Furthermore, a position of the neighboring via 201 where the distance between vias is the reference value “N” may be searched and retrieved.

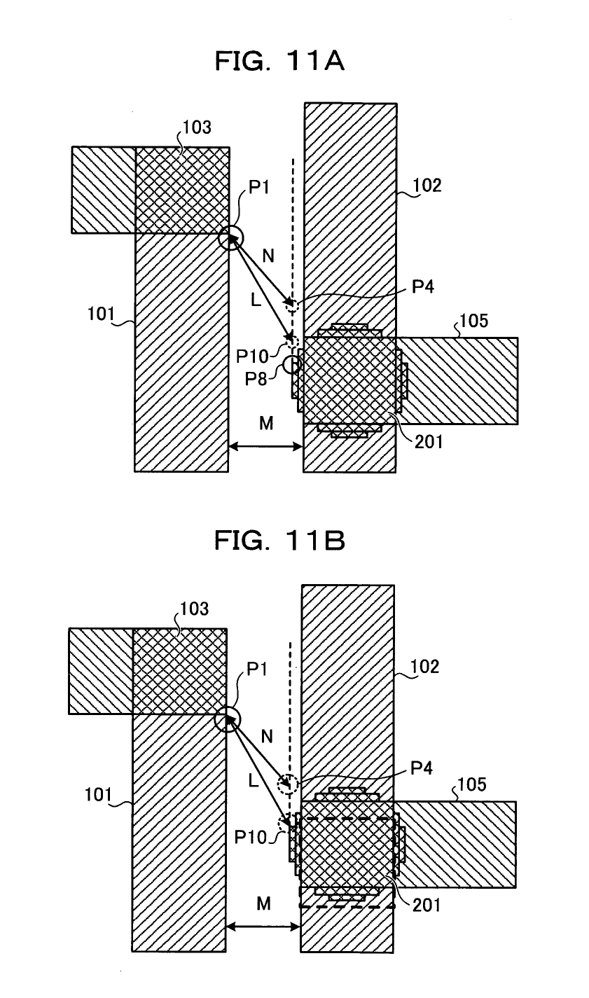

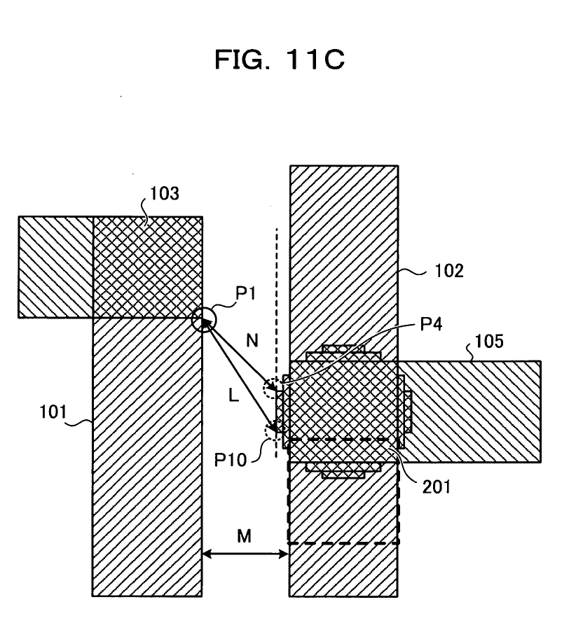

The retrieved result may be stored in a storage device such as the ROM 702, the RAM 703, the magnetic disk 705, and the optical disk 707. FIG. 11A illustrates a position searched by a search unit 805.

FIG. 11A illustrates a position searched by a search unit 805. The point P10 may be a position where the distance between vias is the calculated value “L.” Moreover, the point P4 may be a position where the distance between vias is the reference value “N.” The neighboring via 201 may be arranged in the position between the point P10 and the point P4.

Accordingly, the neighboring via 201 may be automatically rearranged in a direction that the vias are approaching each other compared to before converting the via shapes without violating the design standards. This automatic rearrangement makes the vias closer compared to when the neighboring via 201 is rearranged based only on the calculated value “L.” Thus, an area of a semiconductor integrated circuit may be reduced. Moreover, the factors of design violation found by verification may be reduced. Therefore, returning in design in which vias are rearranged after layout verification may be reduced.

As illustrated in FIG. 8, the conversion unit 806 may convert the position of the neighboring via 201 to the position retrieved by the search unit 805. For example, the CPU 701 may access the storage device and read information on the neighboring via 201 and the coupling target wiring 105 based on the identification information. The CPU 701 may access the storage device, search and retrieve the neighboring via 201 from the physical information of signal wiring 300. Then, coordinates of the neighboring via 201 may be converted to coordinates of the position searched by the search unit 805. The conversion result may be stored in a storage device such as the ROM 702, the RAM 703, the magnetic disk 705, and the optical disk 707.

The conversion unit 806 may convert the position of the coupling target wiring 105 into a position where the coupling target wiring 105 is coupled to the adjacent wiring 102 via the neighboring via 201. For example, the CPU 701 may access the storage device, and may read the coupling target wiring 105 based on the identification information. The CPU 701 accesses the storage device, search, and retrieve start point coordinates and end point coordinates of the coupling target wiring 105 that are included in the physical information of signal wiring 300. Then the start point coordinates of the coupling target wiring 105 may be converted into the coordinates of the neighboring via 201. Travel amounts of coordinates X and Y of start point coordinates before and after the conversion may be calculated. The coordinates obtained by adding the calculated travel amount to the end point coordinates of the coupling target wiring 105 may be assumed as end point coordinates of the coupling target wiring 105.

Layout data in which the positions of the neighboring via 201 and the coupling target wiring 105 are converted may be stored in a database. The converted result may be stored in the ROM 702, the RAM 703, the magnetic disk 705, and the optical disk 707. FIGS. 11B and 11C depict the neighboring via 201 whose position is converted.

FIG. 11B illustrates a neighboring via 201 whose position is converted. The position of the neighboring via 201 may be converted to a position where the distance between vias is the calculated value “L.” The position of the neighboring via 201 after the conversion is closer to the target via 103 compared to the position before the conversion (a quadrilateral region indicated by the dotted line). FIG. 11C illustrates the neighboring via 201 whose position is converted to the position where the distance between vias is the reference value “N.”

FIG. 11C illustrates the neighboring via 201 whose position is converted to the position where the distance between vias is the reference value “N.” The position of the neighboring via 201 may be converted to a position where the distance between vias is the reference value “N.”

The position where the distance between vias is the reference value “N” is closer to the target via 103 compared to the position before conversion (a quadrilateral region indicated by the dotted line) and where the distance between vias is the calculated value “L.”

Accordingly, the neighboring via 201 may be automatically rearranged in a direction that the vias are approaching each other compared to before replacing the via shape of the neighboring via 201. This allows reducing an area of a semiconductor integrated circuit and thereby lowering the price. Moreover, this may eliminate arrangement by manual operation, and lead to reduce burden on the designer. Furthermore, converting only the neighboring via narrows an area for searching a position, and thereby achieves faster processing.

The coupling target wiring 105 may be rearranged to a position where the coupling target wiring 105 is coupled to the neighboring via 201 after converting the position. This may eliminate arranging wiring by manual operation and thereby reduce burden on the designer.

When only the shape of the target via 103 is automatically converted, the vias may be arranged in a direction that the vias are approaching each other compared to before converting the via shape of the target via 203 in substantially the same manner as when only the neighboring via 104 is converted. This allows reducing an area of a semiconductor integrated circuit and thereby lowering the price. Moreover, this may eliminate arrangement by manual operation, and lead to reduce burden on the designer. Furthermore, converting only the target via 103 narrows an area for searching a position, and thereby achieves faster processing.

Now, returning to FIG. 8, processing of the replacement unit 804, the search unit 805 and the conversion unit 806 in the previously described third case will be described in which the replacement unit 804 replaces the shapes of the target via 103 and the neighboring via 104 with the shapes of the exposure patterns.

The replacement unit 804 may replace the shapes of the target via 103 and the neighboring via 104 with the via shape 601 that is the shape of the exposure pattern. First, processing in which the shape of the target via 103 is replaced with the via shape 601 will be described.

For example, the CPU 701 may access the storage device and reads information on the target via 103 based on the identification information. The CPU 701 may access the storage device, search and retrieve the target via 103 from the physical information of signal wiring 300. The via name of the via shape 601 may be written to the name of the target via 103. The neighboring via 104 to which the replacement is applied may be assumed as the neighboring via 201. For example, the neighboring via 104 to which the replacement is applied may be stored in the storage device by adding identification information that indicates the via is the neighboring via 201.

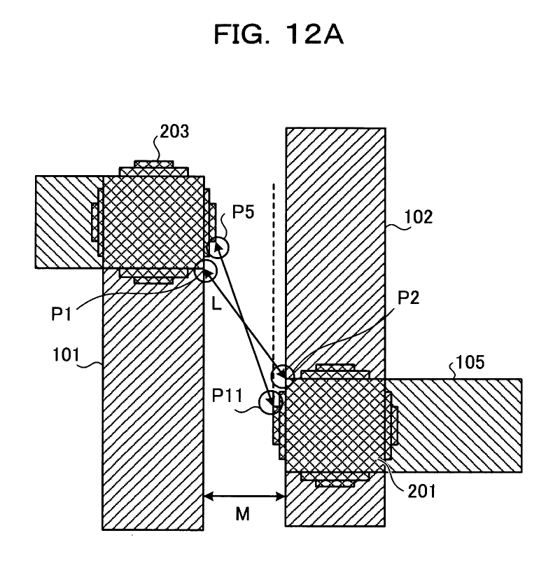

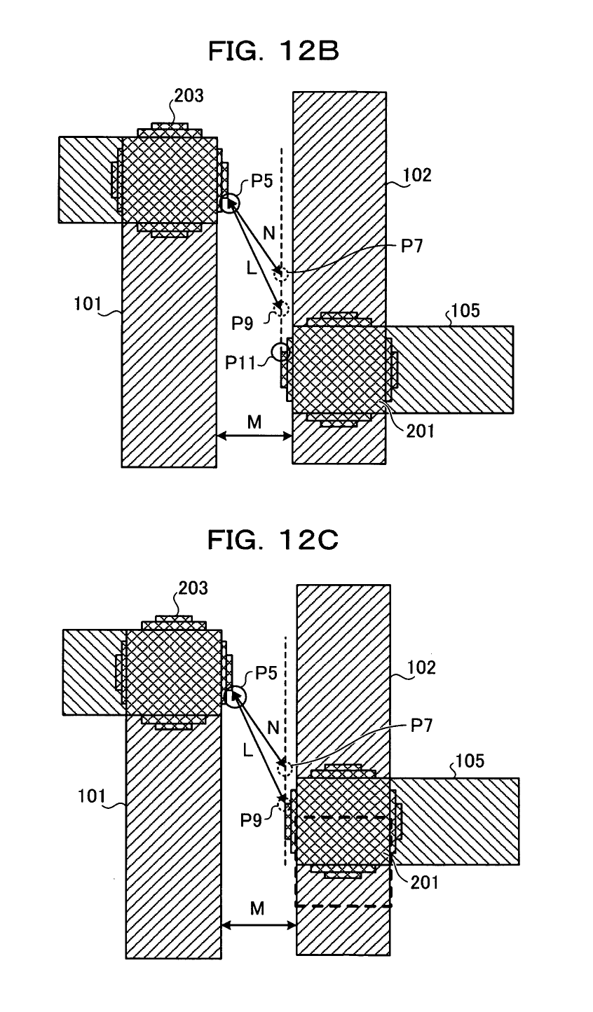

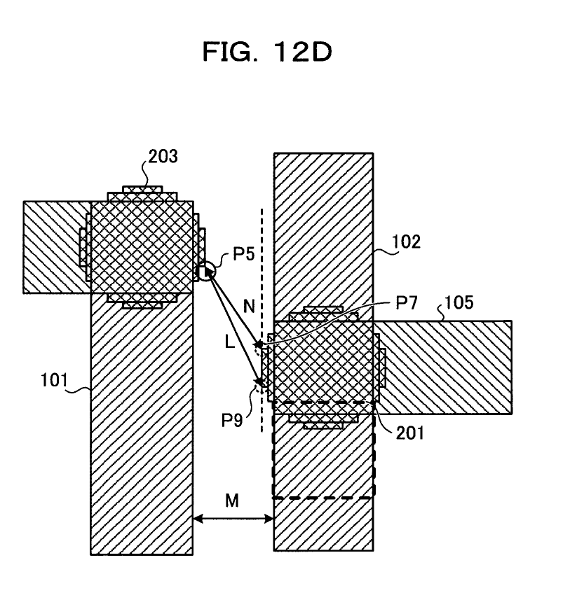

Processing in which the shape of the neighboring via 104 is replaced with the via shape 601 will be described. For example, the CPU 701 may access the storage device, search and retrieve the neighboring via 104 from the physical information of signal wiring 300. The via name of the via shape 601 may be written to the name of the neighboring via 104. The neighboring via 104 to which the replacement is applied may be assumed as the neighboring via 201. For example, the neighboring via 104 to which the replacement is applied may be stored in the storage device by adding identification information that indicates the via is the neighboring via 201. FIG. 12A illustrates an example in which shapes of the target via 103 and the neighboring via 104 are replaced.

FIG. 12A illustrates a target via and a neighboring via whose shapes are replaced by a replacement unit 804. The target via 203 may be a target via 103 whose shape is replaced with the via shape 601 by the replacement unit 804. A distance between vias may be a distance from a point P5 of the target via 203 to a point P11 of the neighboring via 201. In other words, vias may be arranged in a direction that a distance between the vias is longer than the calculated value “L” and the vias are approaching each other.

Now, returning to FIG. 8, the search unit 805 may search and retrieve a position where the distance between the target via 203 and the neighboring via 201 whose shapes are replaced is a standard value “N” or more, and the calculated value “L” or less.

For example, the CPU 701 may access the storage device and read information on the neighboring via 201 based on the identification information. The CPU 701 may access the storage device and search and retrieve the coordinates of the neighboring via 201 from the physical information of signal wiring 300. Then, “B” μm (for example, 0.1 μm) may be added to the coordinates of the neighboring via 201 on the adjacent wiring 102 and in the direction where the target via 203 is arranged. After that, the distance between the vias may be calculated. Moreover, the processing in which B is added to the calculated distance between vias may be repeated. A position of the neighboring via 201 where the distance between vias is the value “L” calculated by the calculation unit 803 may be searched and retrieved. Furthermore, the position of the neighboring via 201 where the distance between vias is the reference value “N” may be searched and retrieved.

The retrieved result may be stored in a storage device such as the ROM 702, the RAM 703, the magnetic disk 705, and the optical disk 707. FIG. 12B illustrates a position searched by a search unit 805.

FIG. 12B illustrates a position searched by a search unit 805. The point P9 may be a position where the distance between the vias is the value “L” calculated by the calculation unit 803. The point P7 may be a position where a distance between the vias is the reference value “N.” The neighboring via 201 may be arranged in a position between the point P9 and the point P7.

Accordingly, the neighboring via 201 may be automatically rearranged in a direction that vias are approaching each other compared to before converting the via shapes without violating the design standards. This automatic rearrangement makes vias closer compared to when the neighboring via 201 is rearranged based only on the distance of vias calculated by the calculation unit 803. Thus, an area of a semiconductor integrated circuit may be reduced. Moreover, the factors of design violation found by verification may be reduced. Therefore, returning in design in which vias are rearranged after layout verification may be reduced.

Now, returning to FIG. 8, the conversion unit 806 may convert the position of the neighboring via 201 to the position retrieved by the search unit 805. Then the position of the coupling target wiring 105 may be converted into the position from where the coupling target wiring 105 is coupled to the adjacent wiring 102 via the neighboring via 201. For example, the CPU 701 may access the storage device and convert coordinates of the neighboring via 201 in the physical information of signal wiring 300 into the coordinates of the retrieved position. Then, start point coordinates of the coupling target wiring 105 may be converted into the coordinates of the neighboring via 201. Travel amounts of coordinates X and Y from the start point coordinates before and after the conversion may be calculated. The coordinates obtained by adding the calculated travel amount to the end point coordinates of the coupling target wiring 105 may be assumed as the end point coordinates of the coupling target wiring 105.

Layout data in which the positions of the neighboring via 201 and the coupling target wiring 105 are converted may be stored in a database. The converted result may be stored in a storage device such as the ROM 702, the RAM 703, the magnetic disk 705, and the optical disk 707. FIGS. 12C and 12D illustrate t the neighboring via 201 whose position is converted.

FIG. 12C illustrates the neighboring via 201 whose position is converted. The position of the neighboring via 201 may be converted to a position where the distance between vias is the calculated value “L.” The converted position may be approaching closer to the target via 203 compared to the position before the conversion (a quadrilateral region indicated by the dotted line). FIG. 12D illustrates the neighboring via 201 whose position is converted to the position where the distance between vias is the reference value “N.”

FIG. 12D illustrates the neighboring via 201 whose position is converted to the position where the distance between vias is the reference value “N.” The position of the neighboring via 201 may be converted to a position where the distance between vias is the calculated value “N.”

The converted position may be approaching closer to the target via 203 compared to the position before the conversion (a quadrilateral region indicated by the dotted line) and the position where the distance between vias is the calculated value “L.”

By automatically converting the shapes of the target via 103 and the neighboring via 104, automatic rearrangement may be applied in a direction that the vias are approaching closer compared to before converting the shapes. The vias may approach closer by converting shapes of the target via 103 and the neighboring via 104 compared to when a shape of only one via is converted. This allows reducing an area of a semiconductor integrated circuit and thereby lowering the price. Moreover, this may eliminate arrangement by manual operation, and lead to reduce burden on the designer.

Now, returning to FIG. 8, the output unit 807 may output a result stored by the conversion unit 806. For example, the CPU 701 may output stored layout data. The output format includes displaying on the display 708, outputting to the printer 713, and transmitting to an external device by the I/F 709. The output data may be stored in a storage device such as the ROM 702, the RAM 703, the magnetic disk 705, and the optical disk 707.

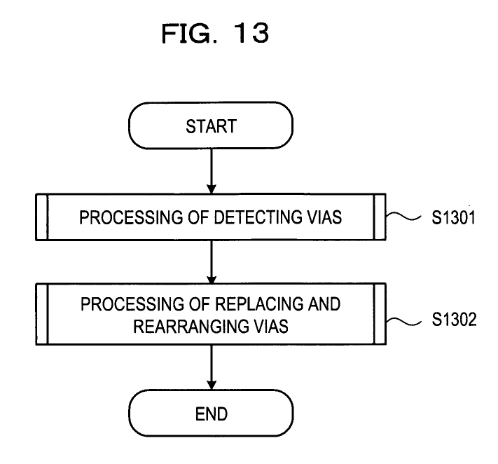

Processing of the design support system 800 according to an embodiment will be described. FIG. 13 is a flow chart illustrating processing procedures of the design support system according to this embodiment. In FIG. 13, first, a database that stores layout data may be accessed, and processing of detecting vias may be performed (Operation S1301). Then, processing of replacing and rearranging vias may be performed (Operation S1302). The series of processing may be completed with this operation.

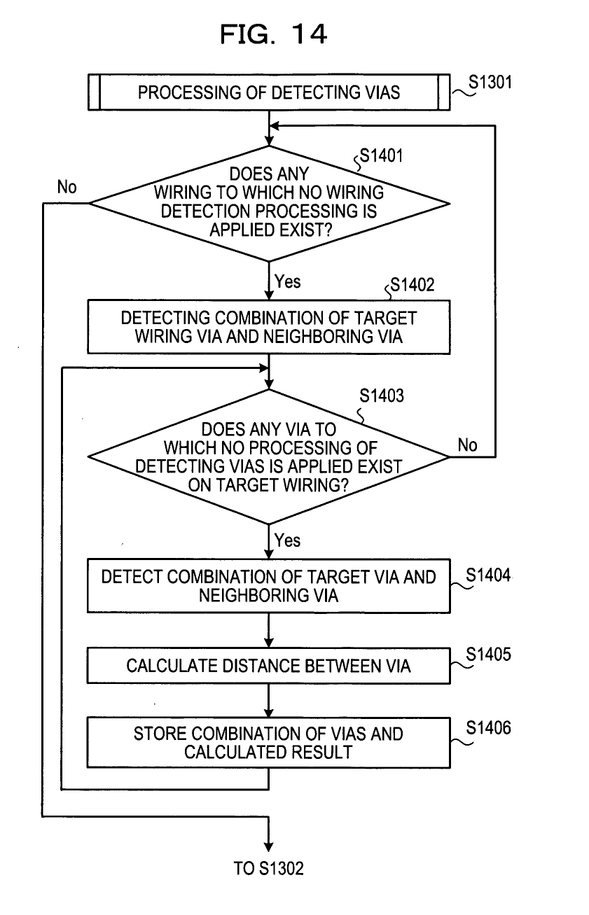

Processing of detecting vias (Operation S1301) will be described. FIG. 14 is a flow chart that illustrates processing of detecting vias. It may be determined whether or not any wiring to which no wiring detection processing is applied exists (Operation S1401). If it is determined that there is a wiring to which no wiring detection is applied (Operation S1401: Yes), the wiring detection unit 801 may detect a combination of wirings comprising a target wiring 101 and an adjacent wiring 102 (Operation S1402), and determines whether or not any via exists on the target wiring to which no processing of detecting vias is applied (Operation S1403).

If it is determined that a via to which no via detection processing is applied exists on the target wiring (Operation S1403: Yes), the via detection unit 802 detects a combination of a target via 103 and a neighboring via 104 (Operation S1404). The calculation unit 803 may calculate the distance between the vias (Operation S1405). The combination of vias and the calculated result may be stored in the storage device (Operation S1406) and the process may return to the Operation S1403.

If it is determined that no via to which via detection is not applied exists on the target wiring (Operation S1403: No), the process returns to the operation S1401. If it is determined that no wiring exists to which detecting the wiring is applied (Operation S1401: No), the process may proceed to the Operation S1302.

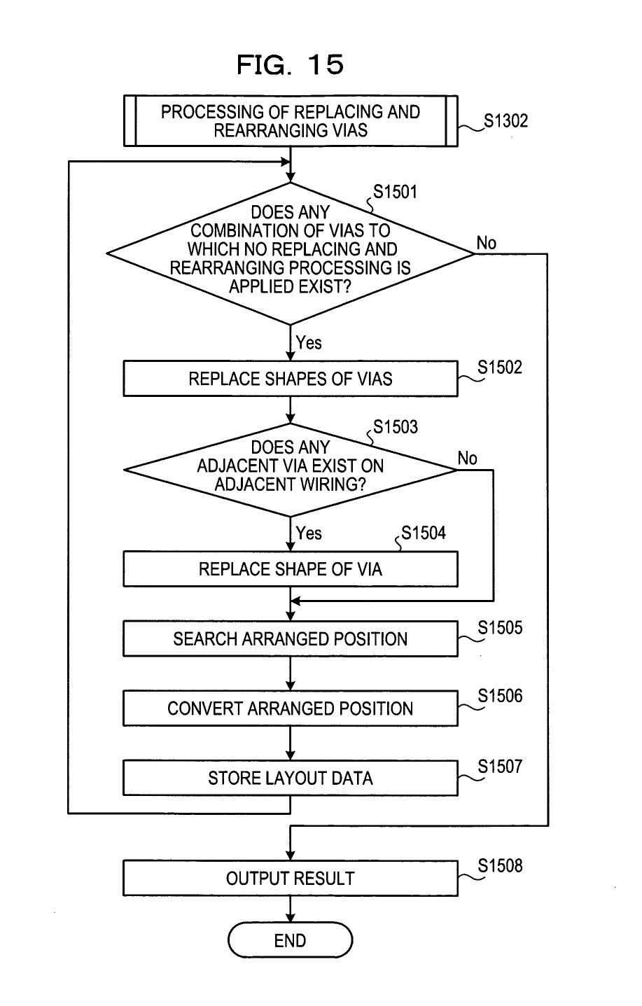

Now, the above described processing of replacing and rearranging vias (Operation S1302) will be described. FIG. 15 illustrates replacing and rearranging vias. It may be determined if there is any combination of vias to which no replacing and rearranging processing is applied (Operation S1501).

If it is determined that a combination of vias exists to which no replacing and rearranging are applied (Operation S1501: Yes), the replacement unit 804 may replace shapes of the vias (Operation S1502). Then, it is determined that if any adjacent via 901 exists on the adjacent wiring (Operation S1503). If it is determined that an adjacent via 901 exists on the adjacent wiring (Operation S1503: Yes), the shape of the via may be replaced with the via shape 602 (Operation S1504). If it is determined that no adjacent via 901 exists on the adjacent wiring (Operation S1503: No), the process may proceed to Operation S1505.

The search unit 805 may search the arranged position of the neighboring via 201 (Operation 81505). The conversion unit 806 may convert the arranged position of the neighboring via 201 (Operation S1506). The layout data may be stored in the storage device (Operation S1507) and the process may return to Operation S1501.

On the other hand, if it is determined that no combination of vias exists to which replacing and rearranging is applied (Operation S1501: No). The output unit 807 outputs the result (Operation S1508) to complete the series of processing.

As described above, according to an exemplary embodiment, two vias may be automatically arranged to approach closer each other by converting a power supply wiring and shapes of the vias on the wiring included in layout data into a via pattern after the fabrication. Furthermore, a distance between vias after converting the shapes of the vias may be a reference value of design standards or more, or a distance between vias before converting the shapes or less.

Therefore, by automatically converting the shapes of the vias, the vias are automatically rearranged in a direction that the vias are approaching closer compared to before the conversion.

According to the design support method, the degree of integration of a semiconductor integrated circuit may be improved by applying the design that assumes phenomena occur during fabrication process.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method for a design support that when executed on a computer executes processes of:
detecting a combination of wirings comprising a target wiring selected from wirings in the layout data and an adjacent wiring that is in parallel with and in substantially the same layer as the target wiring;
detecting a combination of vias comprising a target via selected from rectangular vias arranged on the target wiring and a neighboring via that is in substantially the same layer as the target via and arranged on the adjacent wiring;
calculating a distance between the combination of the target via and the neighboring via detected by the process of detecting the vias;
replacing a shape of the target via and a shape of at least one of the neighboring via with a shape of an exposure pattern of the via;
searching the adjacent wiring arranged within the distance between the vias or less from a position of the target via after the process of replacing;
converting the position of the neighboring via to which the process of replacing is applied to the position searched by the process of searching and storing the position in the database; and
outputting the layout data converted by the process of converting.

2. The method according to claim 1, wherein
the process of replacing comprises replacing the shape of the target via with the exposure pattern of the via; and
the process of searching the position for coupling comprises searching a position where the target via to which the process of the replacing coupled to the adjacent wiring of the neighboring via with the distance between the vias is the calculated distance between the vias or less.

3. The method according to claim 1, wherein
the process of replacing comprises replacing the shape of the neighboring via with the exposure pattern of the via; and
the process of searching for coupling comprises searching a position from where the target via and the adjacent wiring of the neighboring via to which the replacing coupled with the distance between the vias is the calculated distance between vias or less.

4. The method according to claim 1, wherein
the process of replacing comprises replacing the shapes of the target via and the neighboring via with the shapes of the exposure pattern,
the process of searching the position for coupling comprises searching a position from where the target via to which the replacing is applied and the adjacent wiring of the neighboring via to which the replacing coupled with the distance between vias is the calculated distance between vias or less.

5. The method according to claim 1, wherein
the process of searching the position for coupling comprise searching a position from where the target via to which the replacing is applied and the adjacent wiring of the neighboring via to which the replacing coupled with the distance between the vias is a design standard or more and the calculated distance between vias or less.

6. The method according to claim 1, wherein
the process of detecting the combination of the wirings comprises detecting a combination of the adjacent wiring and a coupling target wiring that is coupled to the adjacent wiring by way of the neighboring via; and
the process of converting the retrieved position comprises converting the position of the coupling target wiring based on the position retrieved by the searching.

7. The method according to claim 1, wherein
the process of detecting the combination of the vias comprises detecting a combination of the neighboring via and an adjacent via arranged within a given distance from the neighboring via on the adjacent wiring and in substantially the same layer as the neighboring via;
the process of replacing comprises replacing the shape of the neighboring via with the shape of the exposure pattern of the via except for one side that is facing the adjacent via; and
the process of searching the position for coupling comprises searching a position from where the target via coupled to the adjacent wiring of a neighboring via to which the replacing is applied with the distance between the vias is the calculated distance between vias or less.

8. A design support program causing a computer that accesses a database storing layout data to execute:
detecting a combination of wirings comprising a target wiring selected from wirings in the layout data and an adjacent wiring that is in parallel with and in substantially the same layer as the target wiring;
detecting a combination of vias comprising a target via selected from rectangular vias arranged on the target wiring and a neighboring via that is in substantially the same layer as the target via and arranged on the adjacent wiring;
calculating a distance between the combination of vias comprising the target via and the neighboring via detected by the detecting the vias;
replacing a shape of at least one of the target via and the neighboring via with a shape of an exposure pattern of the via;
searching and retrieving a position from where the target via to which the replacing is applied and the adjacent wiring of the neighboring via to which the replacing coupled with the distance between vias calculated by the calculating or less;
converting the position of the neighboring via to which the replacing is applied to the retrieved position searched by the searching and storing the position in the database; and
outputting the layout data converted by the converting.

9. A design support system, comprising:
detecting a combination of wirings comprising a target wiring selected from wirings in the layout data and an adjacent wiring that is in parallel with and in substantially the same layer as the target wiring;
detecting a combination of vias comprising a target via selected from rectangular vias arranged on the target wiring and a neighboring via that is in substantially the same layer as the target via and arranged on the adjacent wiring;
calculating a distance between the combination of vias comprising the target via and the neighboring via detected by the detecting the vias;
replacing a shape of at least one of the target via and the neighboring via with a shape of an exposure pattern of the via;
searching and retrieving a position from where the target via to which the replacing is applied and the adjacent wiring of the neighboring via to which the replacing coupled with the distance between vias calculated by the calculating or less;
converting the position of the neighboring via to which the replacing is applied to the retrieved position searched by the searching and storing the position in the database; and
outputting the layout data converted by the converting.
